(19) United States
(12) Patent Application Publication
(10) Pub. No.: US 2012/0103296 A1
(43) Pub. Date: May 3, 2012

(54) INTAKE SYSTEM OF INTERNAL COMBUSTION ENGINE

(75) Inventors: Hidefumi KONAKAWA, Toyota-shi (JP); Hideaki TERAMOTO, Kariya-shi (JP)

(73) Assignee: AISIN SEIKI KABUSHIKI KAISHA, Kariya-shi (JP)

(21) Appl. No.: 13/075,912

(22) Filed: Mar. 30, 2011

(30) Foreign Application Priority Data
Nov. 2, 2010 (JP) 2010-246772

(51) Int. Cl. F02M 35/10

(52) U.S. Cl. 123/184.56

(57) ABSTRACT

An intake system of an internal combustion engine includes: an intake manifold; a cartridge provided in the intake manifold, the cartridge having a plurality of intake channels for supplying air to respective cylinders in the internal combustion engine and valve elements configured to adjust the amounts of intake air taken into the respective cylinders; a gas supply portion configured to introduce gas discharged from the internal combustion engine into the cylinders, the gas supply portion being provided at a center position of the cartridge in the direction of row of the plurality of intake channels; and a plurality of gas distribution channels provided on the cartridge and configured to distribute from the gas supply portion to the plurality of intake channels.

### CROSS REFERENCE TO RELATED APPLICATIONS

This application is based on and claims priority under 35 U.S.C. §119 to Japanese Patent Application 2010-246772, filed on Nov. 2, 2010, the entire content of which is incorporated herein by reference.

### TECHNICAL FIELD

This disclosure relates to an intake system of an internal combustion engine including an intake manifold and a cartridge provided in the intake manifold, the cartridge having a plurality of intake channels for supplying air to respective cylinders in the internal combustion engine and valve elements configured to adjust the amounts of intake air taken into the respective cylinders, further including a gas supply portion provided in the cartridge and configured to introduce gas discharged from the internal combustion engine into the cylinders, and gas distribution channels provided in the cartridge so as to extend from the gas supply portion to the plurality of intake channels respectively.

### BACKGROUND DISCUSSION

In the related art, the intake system in the internal combustion engine described above is provided with the gas supply portion on a section of the cartridge on one end side in the direction of row of the plurality of intake channels (hereinafter, referred to as “channel row direction”.

Then, a gas introducing channel configured to introduce gas (exhaust gas) supplied from the gas supply portion into a center position of the cartridge in the channel row direction is provided on the cartridge, and the gas distribution channels, which are extending to the respective intake channels disposed on the left and right sides of a terminal position of the gas introducing channel, are connected to a terminal end of the gas introducing channel (for example, see JP2005-307960A, (Reference 1)).

Therefore, the gas supplied from the gas supply portion passes through the gas introducing channel and the gas distribution channels in sequence while radiating heat to the cartridge.

However, since the gas introducing channel is provided only on a section of the cartridge extending between the side of the gas supply portion and the center position in the channel row direction (hereinafter, referred to as “supply-portion-side section”), the temperature of the supply-portion-side section is liable to rise in comparison with a section on the side where the gas introducing channel is not provided, that is, a section of the cartridge extending from the other end side in the channel row direction and the center position (hereinafter, referred to as “non-supply-portion-side section”).

Consequently, the difference between a temperature distribution in the supply-portion-side section and a temperature distribution in the non-supply-portion-side section is increased, which may lead to heat distortion of the cartridge and impairment of hermeticity of the intake manifold.

In addition, air passing through the intake channels provided in the supply-portion-side section is more vulnerable to temperature rise than air passing through the intake channels provided on the non-supply-portion-side section, and hence combustion characteristics may vary from cylinder to cylinder in the internal combustion engine.

A need thus exists for an intake system of an internal combustion engine which is not susceptible to the drawback mentioned above.

### SUMMARY

According to an aspect of this disclosure, an intake system of an internal combustion engine includes: an intake manifold; a cartridge provided in the intake manifold, the cartridge having a plurality of intake channels for supplying air to respective cylinders in the internal combustion engine and valve elements configured to adjust the amounts of intake air taken into the respective cylinders; a gas supply portion configured to introduce gas discharged from the internal combustion engine into the cylinders, the gas supply portion being provided at a center position of the cartridge in the direction of row of the plurality of intake channels; and a plurality of gas distribution channels provided on the cartridge and configured to distribute from the gas supply portion to the plurality of intake channels.

According to another aspect of this disclosure, an intake system of an internal combustion engine includes: an intake manifold; a cartridge provided in the intake manifold, the cartridge having a plurality of intake channels for supplying air to respective cylinders in the internal combustion engine and valve elements configured to adjust the amounts of intake air taken into the respective cylinders; a gas supply portion provided on the cartridge at a center position of the cartridge in the direction of row of the plurality of intake channels and configured to introduce gas discharged from the internal combustion engine to the cylinders; and a first distribution channel provided in the cartridge so as to extend from the gas supply portion in the direction of row of the plurality of intake channels, and a second distribution channel extending from the first distribution channel to the plurality of intake channels.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exploded perspective view of an intake system of an internal combustion engine;

FIG. 2 is a perspective view of the intake system in the internal combustion engine;

FIG. 3 is a cross-sectional view taken III-III line in FIG. 4;

FIG. 4 is a front view of an intake manifold viewed from the side of a cartridge;

FIG. 5 is a cross-sectional view taken V-V line in

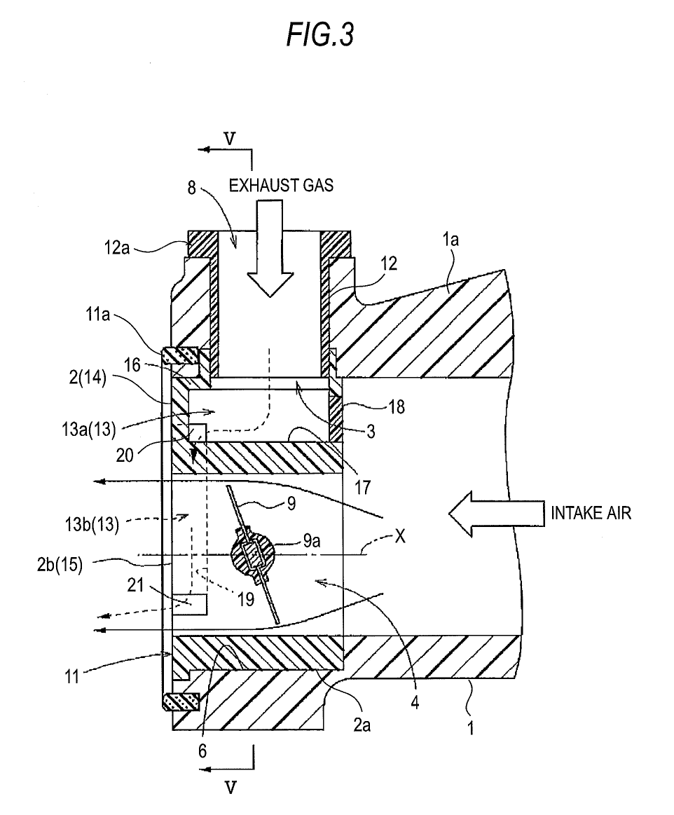

FIG. 3;

FIG. 6 is a vertical cross-sectional view of the intake channels according to the second embodiment;

FIG. 7 is a vertical cross-sectional view of the intake channels according to the third embodiment; and

FIG. 8 is a vertical cross-sectional view of the intake channel according to the fourth embodiment.

### DETAILED DESCRIPTION

Referring now to the drawings, embodiments disclosed here will be described.

### First Embodiment

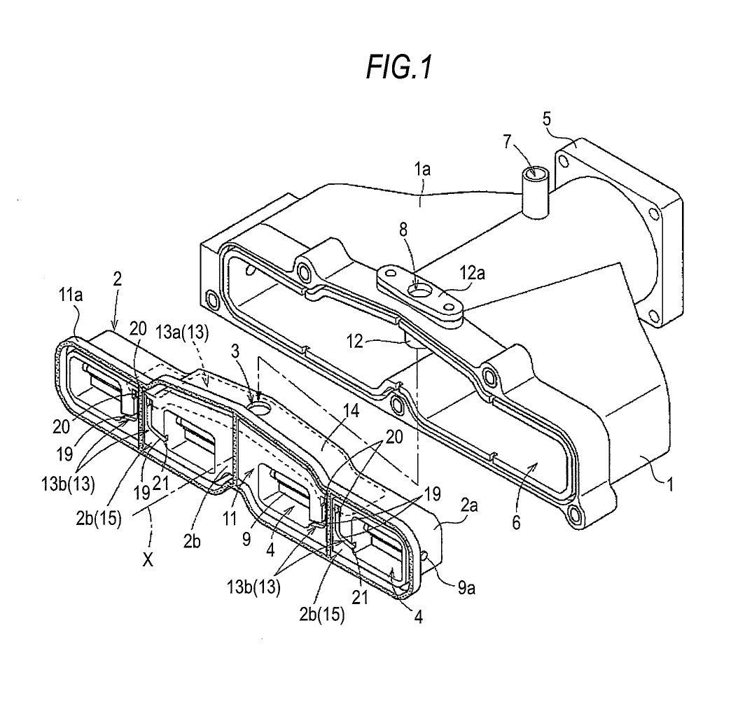

FIGS. 1 to 5 show an intake system of an internal combustion engine according to the first embodiment disclosed here and, more specifically, to an intake manifold of a four-cylinder gasoline engine for an automotive vehicle.

The intake manifold is assembled between a throttle body, not shown, and an intake port of a cylinder head of the engine.

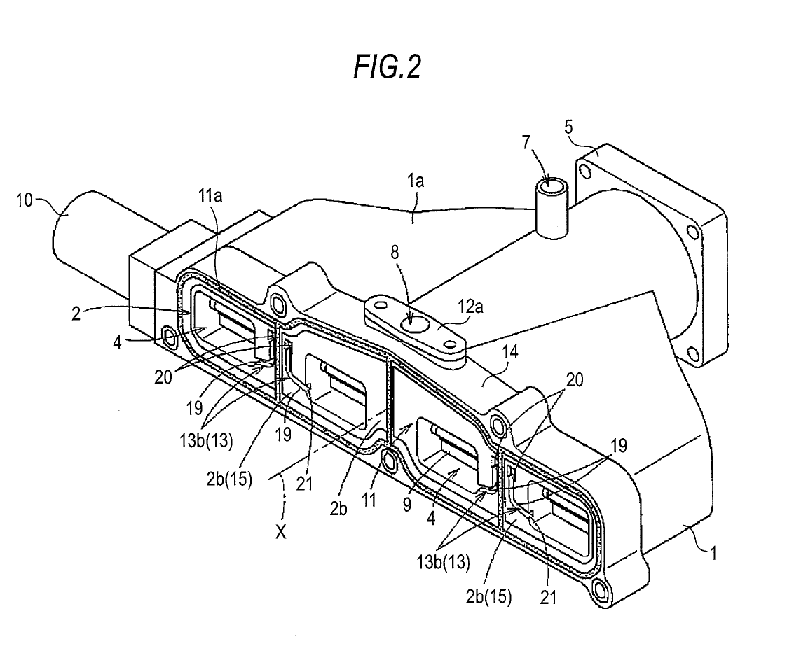

As shown in FIGS. 1 and 2, the intake manifold includes a resin-made intake manifold 1, a resin-made cartridge 2 to be joined to an intake port connecting surface of the cylinder head, not shown, and to be provided on the inductor 1, and an exhaust gas supply portion 3 configured to cause exhaust gas as an example of gas discharged from the engine to circulate through respective cylinders in the engine.

The cartridge 2 is formed with a plurality of (four in the embodiment disclosed here) intake channels 4 configured to supply air (intake air) in the intake manifold 1 to respective cylinders in the engine so as to be arranged substantially in the horizontal direction.

The intake manifold 1 is formed of heat-resistance resin material such as nylon 6, or nylon 6,6. The cartridge 2 is formed of a high-heat resistance resin material such as polyphenylene sulfide resin (PPS) or aromatic nylon (PPA), which have higher heat resistant properties than the resin material which constitutes the intake manifold 1.

The intake manifold 1 includes a throttle body mounting portion 5 and a cartridge mounting opening 6 where the cartridge 2 is inserted and mounted provided so as to oppose to each other.

The intake manifold 1 is formed into the shape of substantially bilateral symmetry with respect to a centerline X of the throttle body mounting portion 5 so as to increase in width as it goes toward the side of the cartridge mounting opening 6.

The cartridge mounting opening 6 is formed into a laterally elongated shape in bilateral symmetry.

An upper wall portion la of the intake manifold 1 is provided with a blow-by gas introducing portion 7 to which a blow-by gas introducing pipe is connected and an exhaust gas introducing portion 8 to which an exhaust gas introducing pipe for introducing exhaust gas from the engine is connected. The blow-by gas introducing portion 7 and the exhaust gas introducing portion 8 are arranged so as to be aligned along the centerline X.

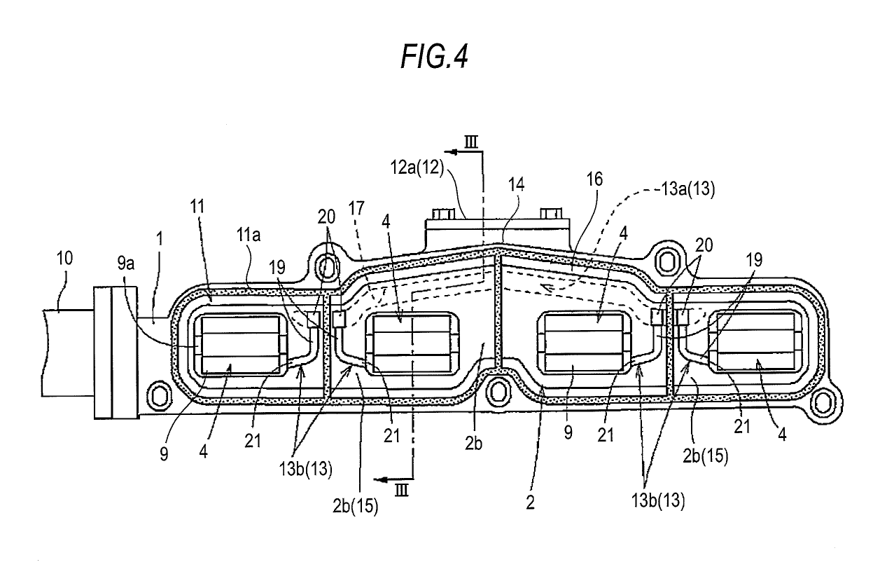

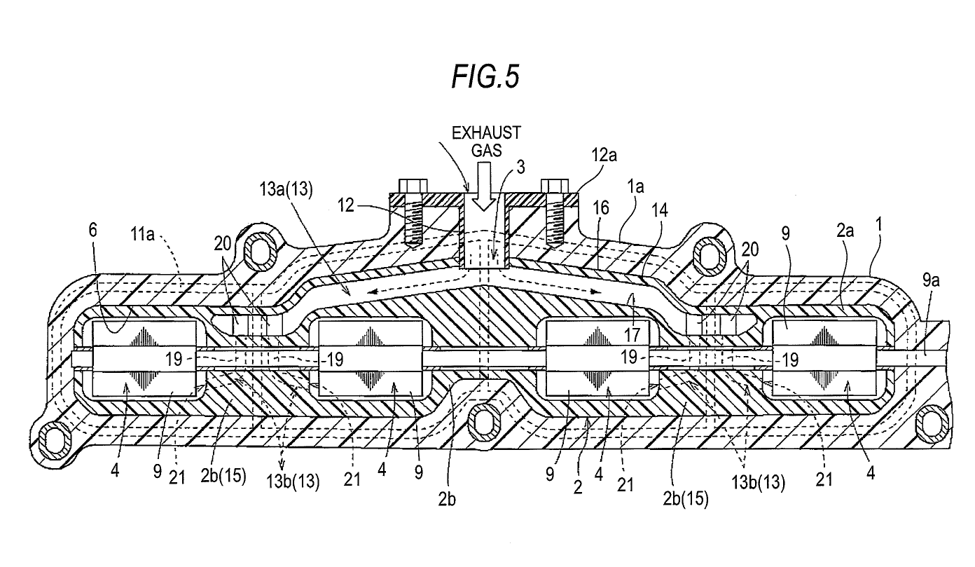

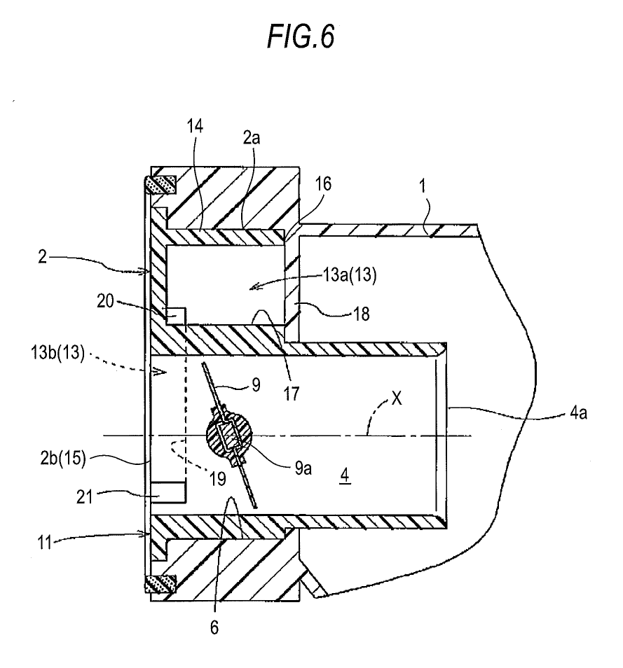

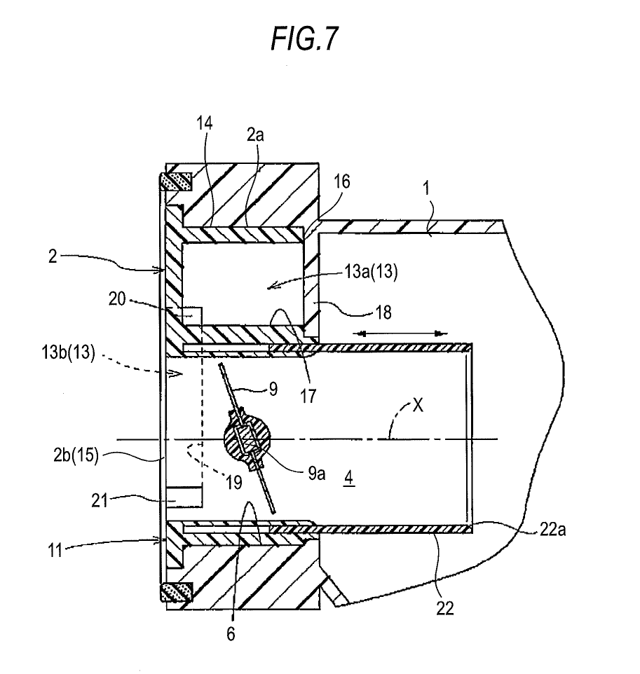

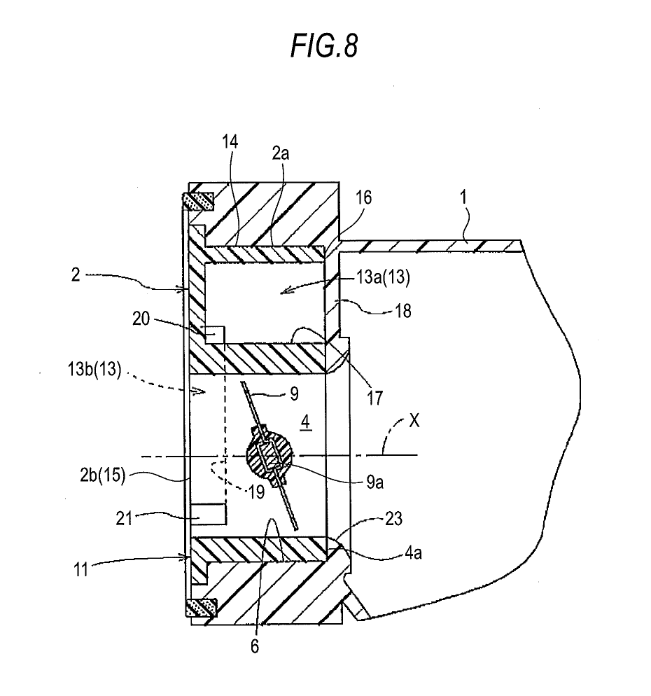

As shown also in FIGS. 4 and 5, the cartridge 2 has a laterally elongated shape in bilateral symmetry having an outer peripheral wall 2a to be joined to an inner peripheral surface along the cartridge mounting opening 6 of the intake manifold 1 and three partition walls 2b partitioning the inside of the outer peripheral wall 2a into the four intake channels 4.

Valve elements 9 configured to adjust the amount of intake air taken into the respective cylinders in the engine are supported by a spindle 9a, which is in turn supported at both ends thereof by the outer peripheral wall 2a in a state of penetrating through the respective partition walls 2b at center positions in the longitudinal direction inside the respective intake channels.

The degrees of opening of the respective valve elements 9 are adjusted by the driving of an electric motor 10.

As shown in FIGS. 3 and 4, the cartridge 2 is formed with a port joint surface 11 which is joined to the intake air port connecting surface of the cylinder head, not shown, with the intermediary of a gasket 11a therebetween, and the cartridge 2 is inserted into the cartridge mounting opening 6 with the port joint surface 11 directed outward.

The port joint surface 11 is formed of an outward oriented end surfaces of the outer peripheral wall 2a and the partition walls 2b.

In the embodiment disclosed above, the cartridge 2 is not welded to the intake manifold 1. However, the cartridge 2 may be welded to the intake manifold 1 by an ultrasonic welding method or the like.

As shown in FIGS. 3 and 5, the exhaust gas introducing portion 8 includes a metallic short pipe 12 provided with a connecting flange 12a to which an exhaust gas introducing pipe, not shown, is connected.

The exhaust gas supply portion 3 is configured to supply exhaust gas introduced from the short pipe 12 into the exhaust gas introducing portion 8 so as to circulate to the respective cylinders, and is provided at a center position of the cartridge 2 in the direction of arrangement of the plurality of intake channels 4.

The cartridge 2 is provided with the plurality of exhaust gas distribution channels 13 distributing from the exhaust gas supply portion 3 to the plurality of intake channels 4.

The exhaust gas distribution channel 13 includes a first distribution channel 13a provided on an upper outer peripheral wall 14 of the outer peripheral wall 2a of the cartridge 2 so as to be branched in bilateral symmetry as shown in FIG. 5, and second distribution channels 13b provided respectively in two compartment walls 15 (2b) which partition the adjacent intake channels 4 at longitudinal end portions of the cartridge 2 as shown in FIG. 4.

Two of the second distribution channels 13b are provided for the each compartment wall 15 for achieving communication with the respective intake channels 4 on both sides of the compartment wall 15.

The first distribution channel 13a is branched from the exhaust gas supply portion 3 obliquely downward in lateral symmetry, and the two second distribution channels 13b are communicated respectively with terminal end portions of the first distribution channel 13a.

The first distribution channel 13a is formed between a first distribution channel forming groove 17 formed on an upper end surface 16 facing the intake manifold side of the upper outer peripheral wall 14 and a resin plate 18 joined to the upper end surface 16 by ultrasonic welding so as to cover the first distribution channel forming groove 17 as shown in FIGS. 3 and 4.

The second distribution channels 13b are formed between second distribution channel forming grooves 19 formed on the port joint surface 11 so as to extend along the vertical direction, and an intake port connecting surface of the cylinder head, not shown, which is joined to the port joint surface 11.

The short pipe 12 for introducing the exhaust gas is inserted into a through hole formed in the upper wall portion la of the intake manifold 1 so as to communicate with a lateral center position of the first distribution channel forming groove 17, and hence is in communication with the first distribution channel forming groove 17.

Communication holes 20 which bring the first distribution channel forming groove 17 into communication with the two second distribution channel forming grooves 19 are formed so as to penetrate through the cartridge 2 at positions corresponding to left and right end portions of the first distribution channel forming groove 17.

Therefore, the cartridge 2 is provided with the plurality of the exhaust gas distribution channels 13 which distribute from the exhaust gas supply portion 3 to the plurality of intake channels 4, and openings 21 are formed respectively on wall surfaces of the plurality of intake channels 4 as terminal end portions of the exhaust gas distribution channels 13.

The first distribution channel forming groove 17 is branched from the exhaust gas supply portion 3 laterally along the longitudinal direction of the cartridge and also along the direction of downward inclination.

The two second distribution channel forming grooves 19 formed so as to extend downwardly corresponding respectively to the left and right end portions of the first distribution channel forming groove 17 are molded so as to extend obliquely downward from a mid position thereof, so that one of the second distribution channel forming grooves 19 is formed so as to open from a wall surface of one of the intake channels 4 on one side with respect to the nozzles 15 and the other second distribution channel forming groove 19 is formed so as to open from a wall surface of the other intake channel 4 on the other side with respect to the nozzle 15.

Therefore, a gradient is given to each of the exhaust gas distribution channels 13 so that the exhaust gas distribution channels 13 do not run backward at any position thereof from the exhaust gas supply portion 3 to the intake channels 4 to the side of the exhaust gas supply portion 3 with respect to a segment extending along the longitudinal direction of the cartridge 2 at the corresponding position, that is, to the upstream side in the direction of exhaust gas supply.

By the provision of the gradient as described above, water cooled and condensed in the exhaust gas distribution channel 13 can be flowed reliably downward to the opening 21 at the terminal end of the exhaust gas distribution channel 13 and discharged to the intake channels 4.

In the first embodiment, the lengths of the plurality of gas distribution channels 13 may be all the same from the gas supply portion 3 to the intake channels 4. Further, the opening areas of the plurality of gas distribution channels 13 may be all the same. Therefore, can be supplied uniform to the intake channels 4.

### Second Embodiment

FIG. 6 is a vertical cross-section of the intake channel 4 according to another embodiment.

In the embodiment disclosed above, a resin plate 18 joined to the upper end surface 16 of the cartridge 2 so as to form the first distribution channel 13a in cooperation with the first distribution channel forming groove 17 is molded integrally with the intake manifold 1.

The intake channels 4 are formed so as to project from the upper end surface 16 toward the intake manifold 1 so as to get significantly into the inside of the intake manifold 1.

Therefore, by forming the intake channels 4 so as to extend to the inside of the intake manifold 1, the length of the intake channels 4 can be extended, and the inertia supercharging effect when the engine revolution is low can be enhanced.

An end surface 4a of a cartridge portion surrounding each of the intake channels 4, which opposes the intake manifold 1, is formed into a bell shape so that the diameter of the intake channel 4 is increased as it goes to the inlet port side.

Other configurations are the same as those in the first embodiment.

### Third Embodiment

FIG. 7 is a vertical cross-section of the intake channel 4 according to another embodiment.

In the embodiment disclosed here, the resin plate 18 joined to the upper end surface 16 of the cartridge 2 so as to form the first distribution channel 13a in cooperation with the first distribution channel forming groove 17 is molded integrally with the intake manifold 1 in the same manner as the second embodiment.

In addition, the cartridge portion surrounding the intake channels 4 is equipped with cylindrical intake channel members 22 on the side of the intake manifold 1 so as to be capable of projecting and retracting, so that the length of the intake channels 4 is expandable and contractible.

An end surface 22a of the intake channel member 22 opposing the intake manifold 1 is formed into a bell shape so that the diameter of the intake channel 4 is increased as it goes to the inlet port side.

According to the embodiment disclosed here, a configuration which can produce the inertia supercharging effect irrespective whether the engine revolution is high or low is achieved, for example, by controlling the length of the intake channels 4 to be longer when the amount of depression of an accelerator pedal is small and hence the engine revolution is low, and to be shorter when the amount of depression of the accelerator pedal is large and hence the engine revolution is high.

Other configurations are the same as those in the first embodiment.

### Fourth Embodiment

FIG. 8 is a vertical cross-section of the intake channels 4 according to another embodiment.

In the embodiment disclosed here, the resin plate 18 joined to the upper end surface 16 of the cartridge 2 so as to form the first distribution channel 13a in cooperation with the first distribution channel forming groove 17 is molded integrally with the intake manifold 1 in the same manner as the second embodiment.

In addition, the intake manifold 1 is molded integrally with a shaping member 23 which shapes the inlet ports of the intake channels 4 into a bell shape so that the diameter thereof is increased as it goes to the inlet port side when being connected to the end surface 4a of the cartridge portion surrounding each of the intake channels 4, which opposes the intake manifold 1.

Other configurations are the same as those in the first embodiment.

### Other Embodiments

The intake system of the internal combustion engine according to embodiments disclosed here may have a hole which defines the exhaust gas distribution channel in the interior of the cartridge.

In the first to fourth embodiments, the cartridge is provided inside the intake manifold 1. In this configuration, the cartridge 2 is assembled to the intake manifold 1 in advance, and the obtained assembly may be assembled to the cylinder head.

Therefore, in comparison with the case where the cartridge 2 is interposed between the intake manifold 1 and the cylinder head, assembly is achieved more easily.

In the first to fourth embodiments, the blow-by gas is introduced into the blow-by gas introducing portion 7, and the exhaust gas is introduced into the exhaust gas introducing portion 8. However, a configuration in which exhaust gas is introduced into the blow-by gas introducing portion 7 instead of the blow-by gas, and the blow-by gas is introduced into the exhaust gas introducing portion 8 instead of the exhaust gas is also applicable.

Alternatively, a configuration in which two types of gases, namely, the blow-by gas and the exhaust gas, are introduced into the exhaust gas introducing portion 8, and the blow-by gas introducing portion 7 is not provided is also applicable.

Furthermore, gas other than the blow-by gas and the exhaust gas (for example, evaporation gas in a fuel tank) may be introduced as the gas to be introduced into the blow-by gas introducing portion 7 and the exhaust gas introducing portion 8.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An intake system of an internal combustion engine comprising:
an intake manifold;
a cartridge provided in the intake manifold, the cartridge having a plurality of intake channels for supplying air to respective cylinders in the internal combustion engine and valve elements configured to adjust the amounts of intake air taken into the respective cylinders;
a gas supply portion configured to introduce gas discharged from the internal combustion engine into the cylinders, the gas supply portion being provided at a center position of the cartridge in the direction of row of the plurality of intake channels; and
a plurality of gas distribution channels provided on the cartridge and configured to distribute from the gas supply portion to the plurality of intake channels.

2. The intake system of the internal combustion engine according to claim 1, wherein the lengths of the plurality of gas distribution channels are all the same from the gas supply portion to the intake channels.

3. The intake system of the internal combustion engine according to claim 1, wherein the opening areas of the plurality of gas distribution channels are all the same.

4. The intake system of the internal combustion engine according to claim 2, wherein the opening areas of the plurality of gas distribution channels are all the same.

5. The intake system of the internal combustion engine according to claim 1, wherein openings are formed on respective wall surfaces of the plurality of intake channels as terminal ends of the gas distribution channels, and
a gradient is given to each of the gas distribution channels so that the gas distribution channels do not run backward at any position thereof from the gas supply portion to the opening to the side of the gas supply portion with respect to a longitudinal direction of the cartridge.

6. The intake system of the internal combustion engine according to claim 2, wherein openings are formed on respective wall surfaces of the plurality of intake channels as terminal ends of the gas distribution channel, and
a gradient is given to each of the gas distribution channels so that the gas distribution channels do not run backward at any position thereof from the gas supply portion to the opening to the side of the gas supply portion with respect to a longitudinal direction of the cartridge.

7. The intake system of the internal combustion engine according to claim 3, wherein openings are formed on respective wall surfaces of the plurality of intake channels as terminal ends of the gas distribution channel, and
a gradient is given to each of the gas distribution channels so that the gas distribution channels do not run backward at any position thereof from the gas supply portion to the opening to the side of the gas supply portion with respect to a longitudinal direction of the cartridge.

8. The intake system of the internal combustion engine according to claim 4, wherein openings are formed on respective wall surfaces of the plurality of intake channels as terminal ends of the gas distribution channel, and
a gradient is given to each of the gas distribution channels so that the gas distribution channels do not run backward at any position thereof from the gas supply portion to the opening to the side of the gas supply portion with respect to a longitudinal direction of the cartridge.

9. The intake system of the internal combustion engine according to claim 1, wherein the cartridge is formed of a resin material having higher heat resistant property than a resin material which constitutes the intake manifold.

10. The intake system of the internal combustion engine according to claim 2, wherein the cartridge is formed of a resin material having higher heat resistant property than a resin material which constitutes the intake manifold.

11. The intake system of the internal combustion engine according to claim 3, wherein the cartridge is formed of a resin material having higher heat resistant property than a resin material which constitutes the intake manifold.

12. The intake system of the internal combustion engine according to claim 4, wherein the cartridge is formed of a resin material having higher heat resistant property than a resin material which constitutes the intake manifold.

13. The intake system of the internal combustion engine according to claim 5, wherein the cartridge is formed of a resin material having higher heat resistant property than a resin material which constitutes the intake manifold.

14. The intake system of the internal combustion engine according to claim 6, wherein the cartridge is formed of a resin material having higher heat resistant property than a resin material which constitutes the intake manifold.

15. The intake system of the internal combustion engine according to claim 7, wherein the cartridge is formed of a resin material having higher heat resistant property than a resin material which constitutes the intake manifold.

16. The intake system of the internal combustion engine according to claim 8, wherein the cartridge is formed of a resin material having higher heat resistant property than a resin material which constitutes the intake manifold.

17. An intake system of an internal combustion engine comprising:
an intake manifold;
a cartridge provided in the intake manifold, the cartridge having a plurality of intake channels for supplying air to respective cylinders in the internal combustion engine and valve elements configured to adjust the amounts of intake air taken into the respective cylinders;
a gas supply portion provided on the cartridge at a center position of the cartridge in the direction of row of the plurality of intake channels and configured to introduce gas discharged from the internal combustion engine to the cylinders; and
a first distribution channel provided in the cartridge so as to extend from the gas supply portion in the direction of row of the plurality of intake channels, and
a second distribution channel extending from the first distribution channel to the plurality of intake channels.

18. The intake system of the internal combustion engine according to claim 17, wherein the lengths are all the same from the gas supply portion to the plurality of intake channels.

19. The intake system of the internal combustion engine according to claim 17, wherein the opening areas of the first distribution channels are all the same.

20. The intake system of the internal combustion engine according to claim 17, wherein the opening areas of the second distribution channels are all the same.
